(19) United States
(12) Patent Application Publication
(10) Pub. No.: US 2024/0006941 A1
(43) Pub. Date: Jan. 4, 2024

(54) ROTOR AND ROTARY ELECTRIC MACHINE

(71) Applicant: HITACHI ASTEMO, LTD., Hitachinaka-shi, Ibaraki (JP)

(72) Inventors: Zhi JING, Hitachinaka-shi (JP); Shinji YAMAZAKI, Hitachinaka-shi (JP); Hiromitsu OKAMOTO, Hitachinaka-shi (JP); Akira FUJIWARA, Hitachinaka-shi (JP); Ryuta KINOSHITA, Hitachinaka-shi (JP); Hiroki NARUSHIMA, Hitachinaka-shi (JP); Keiichiro MARUYAMA, Hitachinaka-shi (JP)

(73) Assignee: HITACHI ASTEMO, LTD., Hitachinaka-shi, Ibaraki (JP)

(21) Appl. No.: 18/252,784

(22) PCT Filed: Aug. 31, 2021
(86) PCT No.: PCT/JP2021/032018

§ 371 Date: May 12, 2023

(30) Foreign Application Priority Data
Nov. 16, 2020 (JP) 2020-190581

(51) Int. Cl. H02K 1/32

(52) U.S. Cl. CPC H02K 1/32

(57) ABSTRACT

A rotor for a rotary electric machine includes: a rotor core; a shaft that is hollow and that supports the rotor; and an end plate that is disposed on an end of the rotor in a rotational axis direction, and that forms a passage through which a refrigerant flows, between the end plate and the rotor core, in which the end plate includes a plurality of ribs that come into contact with the shaft, the passage includes a refrigerant entry portion that is provided between the plurality of ribs, and a refrigerant exit portion that communicatively connects the refrigerant entry portion to an outer peripheral surface of the end plate, the shaft has a refrigerant supply hole communicatively connecting the refrigerant entry portion to internal of the shaft, and a circumferential length of the refrigerant entry portion along an innermost diameter is larger than a circumferential length of the refrigerant supply hole.

### TECHNICAL FIELD

The present invention relates to a rotor and a rotary electric machine using the rotor.

### BACKGROUND ART

In recent years, in a motor mounted on an automobile, for example, a stricter cooling requirement has come to be imposed on coils, as the output becomes higher. With regard to the cooling of coils, a technology according to PTL 1 has been known. PTL 1 discloses a cooling structure for an electric motor that includes a rotator core into which a rotation shaft is inserted, a stator core fixed to a casing, and end plates provided on respective ends of the rotator core, in which at least one core of the rotator core and the stator core is configured to have a magnetic pole that changes with a change in current; at least the other core of the two cores is configured to come to have a magnetic pole with a permanent magnet, and each of the end plates includes a refrigerant passage that is formed as a groove and provided between a wall surface of the end plate and an end surface of the rotator core in an axial direction, a supply hole through which a refrigerant is supplied and that is communicatively connected to the refrigerant passage, and a first outlet through which the refrigerant is discharged and that is communicatively connected to the refrigerant passage. In this cooling structure for an electric motor, the end plate is circumferentially provided with a discharge groove along an outer periphery of the refrigerant passage, and the discharge groove has a second outlet for discharging the refrigerant from the discharge groove, on the outer periphery side of the refrigerant passage.

### CITATION LIST

### Patent Literature

PTL 1: JP 2011-142788 A

### SUMMARY OF INVENTION

### Technical Problem

In the cooling structure according to PTL 1, by communicatively connecting the refrigerant passage of the rotation shaft with the refrigerant passages of the end plates, the refrigerant is supplied from the rotation shaft to the coils of the stator, via the end plates. Therefore, it is necessary to align the rotation shaft and the end plates accurately at the time of assembling the motor, and there is also strict demands for machining accuracy and assembling accuracy of these components. Therefore, there has been a problem that a larger number of hours is required in manufacturing the motor, and leads to an increase in cost.

### Solution to Problem

A rotor for a rotary electric machine according to the present invention includes: a rotor core; a shaft that is hollow and that supports the rotor; and an end plate that is disposed on an end of the rotor in a rotational axis direction, and that forms a passage through which a refrigerant flows, between the end plate and the rotor core, in which the end plate includes a plurality of ribs that come into contact with the shaft, the passage includes a refrigerant entry portion that is provided between the plurality of ribs, and a refrigerant exit portion that communicatively connects the refrigerant entry portion to an outer peripheral surface of the end plate, the shaft has a refrigerant supply hole communicatively connecting the refrigerant entry portion to internal of the shaft, and a circumferential length of the refrigerant entry portion along an innermost diameter is larger than a circumferential length of the refrigerant supply hole.

A rotary electric machine according to the present invention includes a rotor for a rotary electric machine, and a stator disposed outside the rotor with a predetermined gap therebetween.

### Advantageous Effects of Invention

According to the present invention, it is possible to provide a rotor and a rotary electric machine capable of reducing the cost while exerting high coil cooling performance.

### BRIEF DESCRIPTION OF DRAWINGS

FIG. 1 is a schematic cross-sectional view showing a configuration of a rotary electric machine according to an embodiment of the present invention.

FIG. 2 is a view showing an external appearance and a structure of an end plate.

FIG. 3 is a view for describing a positional relationship between ribs and holes on the end plate.

FIG. 4 is a view for describing a positional relationship between refrigerant entry portions on the end plate and refrigerant supply holes on a shaft.

### DESCRIPTION OF EMBODIMENTS

An embodiment of the present invention will now be described with reference to some drawings.

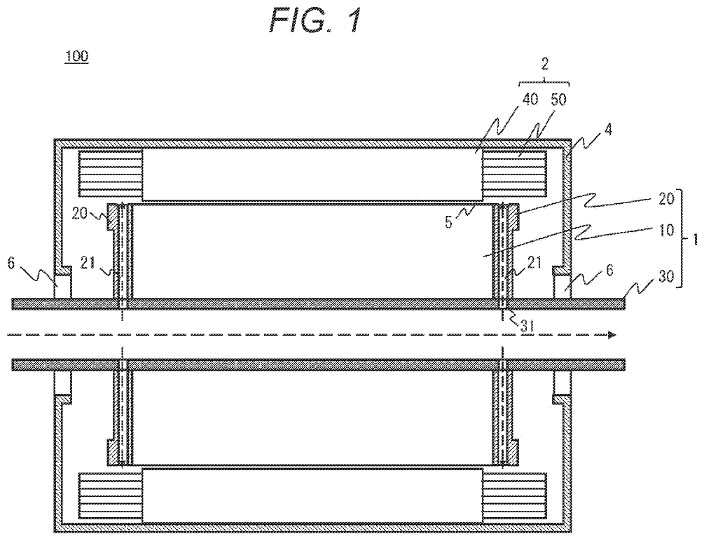

FIG. 1 is a schematic cross-sectional view showing a configuration of a rotary electric machine according to an embodiment of the present invention. A rotary electric machine 100 shown in FIG. 1 includes a rotor 1, a stator 2, and a case 4, and is driven in rotation with a shaft 30 included in the rotor 1 as a rotational axis. The rotary electric machine 100 is used, for example, as a motor for driving an automobile, and outputs a rotational torque to a driving wheel of the automobile via the shaft 30, a gear box, not shown, and the like. FIG. 1 schematically shows a positional relationship among the components of the rotary electric machine 100 described above, with the rotary electric machine 100 cut along a cross section passing through the central axis of the shaft 30. The rotary electric machine 100 is not limited to a motor for driving an automobile, and may be used for any other purposes.

The rotor 1 includes a rotor core 10, end plates 20, and the shaft 30. The rotor core 10 and the end plates 20 are mounted on the shaft 30, and are driven in rotation with the shaft 30. The rotor core 10 includes magnetic field generating elements such as permanent magnets or windings, not shown, and uses these magnetic field generating elements to generate a magnetic field around the rotor core. The end plates 20 are disposed adjacently to respective axial ends of the rotor core Through-holes are provided at radial centers of the rotor core 10 and the end plates 20, respectively, and the shaft 30 passes through the through-holes. In this manner, the rotor core 10 and the end plate 20 are mounted on the shaft 30.

The stator 2 is disposed outside the rotor 1 with a predetermined gap 5 therebetween, and includes a stator core 40 and a plurality of stator coils 50. In the stator core 40, a plurality of slots, not shown, extending in the axial direction are arranged side by side in the circumferential direction, and the stator 2 is formed by inserting one or a plurality of layers of the stator coil 50 into each of such slots. The stator coils 50 are connected to each other at coil ends that are provided on the respective ends of the stator core 40, and are connected to an inverter, not shown. The alternating current supplied from the inverter flows through the stator coils 50, so that a rotating magnetic field is generated in the stator 2. This rotating magnetic field generates a repulsive force and an attractive force with the magnetic field of the rotor 1, and causes the rotor 1 to be driven in rotation.

The shaft 30 has a hollow shape, and has insulating refrigerant (e.g., oil) flowing inside. In the rotor 1, each of the end plates 20 has a plurality of refrigerant exit portions 21 extending in radial directions. The refrigerant exit portions 21 are disposed communicatively with respective refrigerant supply holes 31 of the shaft 30, so that the refrigerant coming out of the shaft 30 via the refrigerant supply holes 31 is discharged near the stator 2. As a result, the refrigerant absorbs the heat of the stator coils 50 in the stator 2, and the stator coils 50 are cooled thereby.

The case 4 is disposed covering the outside of rotor 1 and the stator 2, and is in contact with the shaft 30, with bearings 6 interposed therebetween. In this manner, the internal space of the case 4 is sealed, to prevent the refrigerant from leaking outside of the case 4. The refrigerant coming out of the refrigerant supply holes 31 of the shaft 30 passes through the refrigerant exit portions 21 of the end plate 20, is discharged near the stator 2, absorbs the heat of the stator coils 50, and then is discharged through outlets, not shown, provided to the case 4.

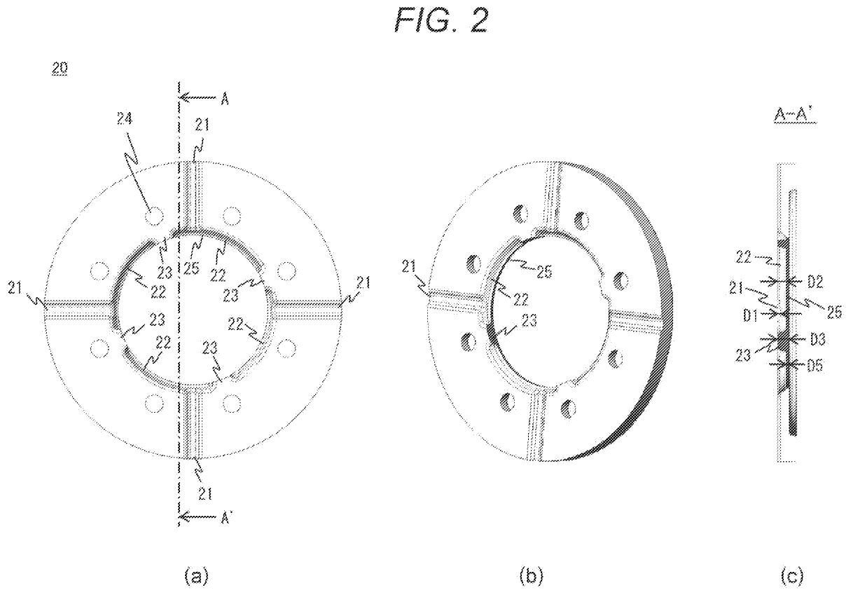

FIG. 2 is a view showing an external appearance and a structure of the end plate 20. In FIG. 2, (a) is a front view of the end plate 20 as viewed from the side of the rotor core 10; (b) is a perspective view of the end plate 20; and (c) is a cross-sectional view of the end plate 20. The cross-sectional view in (c) shows a cross section taken along line A-A′ indicated in (a).

The end plate 20 has a plurality of refrigerant entry portions 22, a plurality of ribs 23, and a plurality of holes 24, in addition to refrigerant exit portions 21 described above. On the inner wall of the through-hole of the end plate 20, the ribs 23 are provided at predetermined intervals in the circumferential direction. The ribs 23 are brought into contact with the shaft 30 (see FIG. 1) passing through the through-hole, and generate a frictional force with the shaft 30.

The refrigerant entry portions 22 are recessed parts provided on the inner wall of the through-hole of the end plate 20, between the rib 23 and the rib 23 that are adjacent to each other in the circumferential direction, the recessed parts being recessed outwards in the radial directions. To the outer periphery of each of the refrigerant entry portions 22, corresponding one of the refrigerant exit portions 21 is connected. Accordingly, the refrigerant entry portions 22 become communicatively connected with the outer peripheral surface of the end plate 20, via the respective refrigerant exit portions 21. Therefore, each of the refrigerant entry portions 22 and corresponding one of the refrigerant exit portions 21 can form a passage through which the refrigerant flows between the rotor core 10 and the end plate 20.

As shown in FIG. 2(c), an axial length D1 of the refrigerant exit portion 21 is smaller than an axial length D2 of the refrigerant entry portion 22. In other words, the cross-sectional area of the refrigerant exit portion 21 is smaller than the cross-sectional area of the refrigerant entry portion 22. In this manner, it is possible to increase the flow velocity of the refrigerant as the refrigerant supplied through the refrigerant supply holes 31 (see FIG. 1) of the shaft 30 flows into the respective refrigerant exit portions 21 via the respective refrigerant entry portions 22. As a result, as described above, it becomes possible to increase the momentum (dynamic pressure) of the refrigerant discharged from the refrigerant exit portions 21 to near the stator 2, so the stator coil 50 can be cooled efficiently.

The end plate 20 has an annular wall portion 25 positioned adjacently to the refrigerant entry portions 22 in the axial direction, in a manner connecting the plurality of ribs 23 on the surface that comes into contact with the shaft 30. In other words, the refrigerant entry portions 22 have one ends thereof in the axial direction positioned adjacently to the wall portion 25. The wall portion 25 extends across the entire circumference in the circumferential direction, along the inner wall of the through-hole of the end plate 20.

In the same manner as the ribs 23, the wall portion 25 comes into contact with the shaft 30 passing through the through-hole, and generates frictional force with the shaft 30. In other words, with the ribs 23 and the wall portion 25, the shaft is aligned with respect to the end plate 20, and the end plate 20 is supported on the shaft 30.

Assuming a configuration without any ribs 23, it is necessary to increase the axial length (length D5) of the wall portion 25 to align the end plate 20 with respect to the shaft stably. Such a configuration leads to an increase in the weight of the end plate 20.

In this embodiment, with the rib 23 and the wall portion the end plate 20 can be aligned with respect to the shaft stably. Therefore, compared with the configuration in which no rib 23 are provided and the end plate 20 is aligned only with the wall portion 25, the thickness (length D5) of the wall portion 25 can be reduced. Therefore, the weight of the end plate 20 can be reduced.

As shown in FIG. 2(c), the axial length D5 of the wall portion 25 may be smaller than the axial length D3 of the ribs 23. Accordingly, because the thickness (length D5) of the wall portion 25 can be reduced, a further reduction in the weight of the end plate 20 can be achieved.

The holes 24 pass through the end plate 20 in the axial direction, and are disposed in a manner surrounding the through-hole. On the end plate 20, the ribs 23 and the holes 24 are arranged in a predetermined positional relationship, as will be described below.

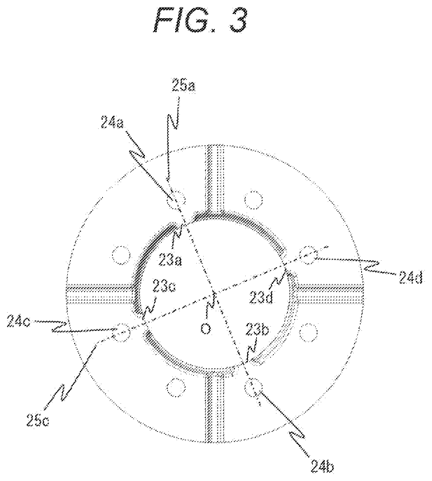

FIG. 3 is a view showing a positional relationship between the ribs 23 and the holes 24 on the end plate 20. In the same manner as in FIG. 2(a), FIG. 3 shows a front view of the end plate 20 as viewed from the side of the rotor core 10. To distinguish the four ribs 23 provided on the end plate 20 from one another, different reference numerals 23a to 23d are given to the respective ribs, in FIG. 3. The holes 24 closest to the respective ribs 23a to 23d are shown as holes 24a to 24d, respectively.

At this time, as shown in FIG. 3, a straight line passing through the center of the hole 24a and the center of the hole 24b that is positioned facing the hole 24a with the through-hole therebetween is defined as an imaginary line 25a. In the same manner, a straight line passing through the center of the hole 24c and the center of the hole 24d that is positioned facing the hole 24c with the through-hole therebetween is defined as an imaginary line 25c. These imaginary lines 25a and 25c pass through the center O of the through-hole, and intersect each other at the center O. The imaginary line 25a passes through the ribs 23a and 23b, and the imaginary line 25c passes through the ribs 23c and 23d.

The holes 24a to 24d and the ribs 23a to 23d have the positional relationship described above. In other words, the ribs 23a and 23b are disposed on the imaginary line 25a connecting the holes 24a and 24b and the center O of the through-hole of the end plate 20, and the ribs 23c and 23d are disposed on the imaginary line 25c connecting the holes 24c and 24d and the center O. With this configuration, when the operator fits the shaft 30 into the end plate 20 in the process of assembling the rotary electric machine 100, the operator can easily align the refrigerant supply holes 31 of the shaft 30 to the refrigerant entry portions 22 provided to the end plate 20, respectively, using the positions of the holes 24a to 24d as a reference. In other words, with the end plate 20 mounted on an axial end of the rotor core 10, the ribs 23 and the refrigerant entry portions 22 are positioned facing the rotor core 10. Therefore, the operator cannot visually check these positions. However, because the ribs 23a to 23d and the holes 24a to 24d are in the positional relationship described above, the operator can insert and fix the shaft 30 into the through-holes of the end plate 20 and the rotor core 10 in such a manner that the positions of the holes 24a to 24d and the refrigerant supply holes 31 do not match in the circumferential direction. In this manner, it is possible to prevent the ribs 23a to 23d from blocking the refrigerant supply holes 31, respectively, without the use of a special positioning jig, for example, and to connect the refrigerant supply holes 31 communicatively with the respective refrigerant entry portions 22, reliably.

As shown in FIG. 3, in the end plate 20, holes 24 are formed around the through-hole, in addition to the holes 24a to 24d disposed at positions corresponding to the ribs 23a to 23d. In a view of the end plate 20 from the side opposite to the surface mounted on the rotor core 10, these holes 24 cannot be distinguished from one another. Although the holes 24 are indistinguishable, by performing the operation described above, the operator can connect the refrigerant supply holes 31 communicatively to the respective refrigerant entry portions 22, reliably. In other words, by mounting the shaft 30 in such a manner that the positions of none of the holes 24 and the refrigerant supply holes 31 overlap each other in the circumferential direction, it is possible to prevent the ribs 23a to 23d from blocking the respective refrigerant supply holes 31.

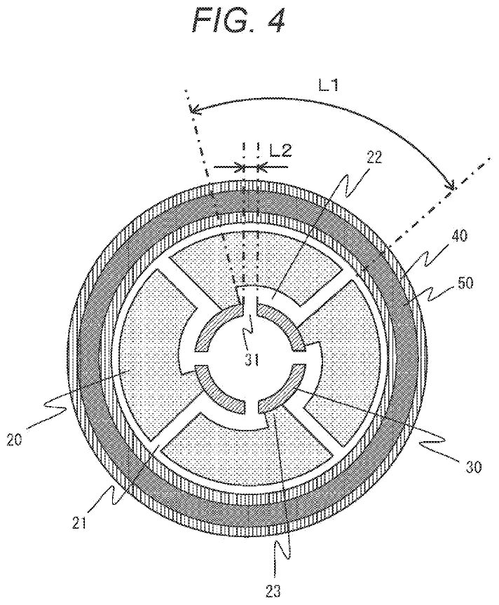

FIG. 4 is a diagram showing a positional relationship between the refrigerant entry portions 22 of the end plate 20 and the refrigerant supply holes 31 of the shaft 30. The end plate 20 is mounted by inserting the shaft 30 into the through-hole, with the refrigerant supply holes 31 communicatively connected to the respective refrigerant entry portions 22, the communicative connection achieved by the alignment described with reference to FIG. 3. As a result, the refrigerant entry portions 22 become communicatively connected to internal of the shaft 30 via the respective refrigerant supply holes 31, and the refrigerant flowing through the internal of the shaft 30 can be supplied into the refrigerant entry portions 22 via the respective refrigerant supply holes 31.

At this time, the positional relationship between the refrigerant entry portions 22 and the refrigerant supply holes 31 is as shown in FIG. 4, for example. Specifically, denoting a circumferential length of the innermost diameter of the refrigerant entry portion 22 as L1, and denoting a circumferential length of the refrigerant supply hole 31 as L2, a relationship of L1>L2 is established. In other words, a circumferential length L1 of the innermost diameter of the refrigerant entry portion 22 is larger than the circumferential length L2 of the refrigerant supply hole 31 provided to the shaft 30. As a result, the refrigerant supply hole 31 is allowed to be displaced in the circumferential direction within the range of (L1−L2) with respect to the refrigerant entry portion 22. This allowance makes the alignment between the refrigerant entry portion 22 and the refrigerant supply hole 31 easier, at the time of assembly.

In the conventional structure as in PTL 1, because L1=L2, and in order to connect the refrigerant entry portions 22 communicatively to the respective refrigerant supply holes 31 in complete alignment, it is necessary to match their positions in the circumferential direction highly precisely. Therefore, very precise machining tolerance and assembly tolerance have been required for the end plate 20 and the shaft 30, and high-precision machining, e.g., cutting the refrigerant entry portion 22, and high-precision assembly using of a jig or the like has been needed. These requirements have led to a cost increase. By contrast, in the structure according to this embodiment, the relationship L1>L2 facilitates the alignment of the refrigerant entry portions 22 with respect to the respective refrigerant supply holes 31. As a result, the conventionally demanded machining tolerances and assembly tolerances of the end plates 20 and the shaft 30 are alleviated. Therefore, it is possible to reduce the number of hours required in manufacturing the rotary electric machine 100, and to achieve a cost reduction.

According to the embodiment of the present invention described above, the following actions and effects can be achieved.
(1) The rotor 1 of the rotary electric machine 100 includes a rotor core 10, a shaft 30 that is hollow and that supports the rotor 1, and an end plate 20 that is disposed on an end in a rotational axis direction of the rotor 1, and that forms a passage through which a refrigerant flows, between the end plate and the rotor core 10. The end plate 20 includes a plurality of ribs 23 coming into contact with the shaft 30, and the passage provided to the end plate 20 includes a refrigerant entry portion 22 provided between the plurality of ribs 23, and a refrigerant exit portion 21 communicatively connecting the refrigerant entry portion 22 and the outer peripheral surface of the end plate 20. The shaft 30 has the refrigerant supply hole 31 via which the refrigerant entry portion 22 is connected communicatively to the internal of the shaft 30. The circumferential length L1 of the refrigerant entry portion 22 along the innermost diameter is larger than a circumferential length L2 of the refrigerant supply hole 31. With this configuration, it is possible to provide a rotor for a rotary electric machine, capable of reducing costs while exerting high coil cooling performance.
(2) The axial length D1 of the refrigerant exit portion 21 is smaller than the axial length D2 of the refrigerant entry portion 22. In this manner, the momentum of the refrigerant discharged from the refrigerant exit portion 21 near the stator 2 can be increased, and the stator coil 50 can be cooled efficiently.
(3) The end plate 20 has holes 24a to 24d that axially pass through the end plate 20, and a through-hole that is provided with the ribs 23a to 23d and through which the shaft is passed. The ribs 23a and 23b are disposed on the imaginary line 25a connecting the hole 24a and 24b and the center O of the through-hole, and the ribs 23c and 23d are disposed on the imaginary line 25c connecting the hole 24a and 24d and the center Thus, when the operator fits the shaft 3 into the end plate the operator can easily align the refrigerant supply holes 31 of the shaft 3 with the refrigerant entry portions 22 of the end plate 20, respectively, using the positions of the holes 24a to 24d as a reference.
(4) The end plate 20 has a wall portion 25 having an annular shape, on a surface coming into contact with the shaft across the entire circumference in the circumferential direction. The wall portion 25 may be configured to have an axial length D5 that is smaller than the axial length D3 of the ribs 23. In this manner, the weight of the end plate 20 can be reduced.
(5) The refrigerant entry portion 22 has one end thereof in the axial direction positioned adjacently to the wall portion With this configuration, the refrigerant flowing into the refrigerant entry portions 22 via the respective refrigerant supply holes 31 is prevented from leaking out of the end plate and the refrigerant can be discharged near the stator 2 via the refrigerant exit portions 21 reliably.
(6) The rotary electric machine 100 includes a rotor 1 and a stator 2 that is disposed outside the rotor 1 with a predetermined gap 5 therebetween. With this configuration, it is possible to provide rotary electric machine 100 capable of reducing the cost while exerting high coil cooling performance.

Note that the embodiments and various modifications described above are merely examples, and the present invention is not limited to such examples, as long as the features of the invention are not impaired. For example, the numbers of the refrigerant exit portions 21, the refrigerant entry portions 22, the ribs 23, and the holes 24 in the end plate 20 are not limited to those described in the embodiment, and may be any number. Furthermore, although various embodiments and modifications have been described above, the present invention is not limited thereto. Other aspects conceivable within the scope of the technical idea of the present invention also fall within the scope of the present invention.

### REFERENCE SIGNS LIST

1 rotor
2 stator
4 case
5 gap
6 bearing
10 rotor core
20 end plate
21 refrigerant exit portion
22 refrigerant entry portion
23 rib
24 hole
25 wall portion
30 shaft
40 stator core
50 stator coil
100 rotary electric machine

1. A rotor for a rotary electric machine, the rotor comprising:
a rotor core;
a shaft that is hollow and that supports the rotor; and
an end plate that is disposed on an end of the rotor in a rotational axis direction, and that forms a passage through which a refrigerant flows, between the end plate and the rotor core,
wherein the end plate includes a plurality of ribs that come into contact with the shaft,
the passage includes a refrigerant entry portion that is provided between the plurality of ribs, and a refrigerant exit portion that communicatively connects the refrigerant entry portion to an outer peripheral surface of the end plate,
the shaft has a refrigerant supply hole communicatively connecting the refrigerant entry portion to internal of the shaft, and
a circumferential length of the refrigerant entry portion along an innermost diameter is larger than a circumferential length of the refrigerant supply hole.

2. The rotor for a rotary electric machine according to claim 1, wherein an axial length of the refrigerant exit portion is smaller than an axial length of the refrigerant entry portion.

3. The rotor for a rotary electric machine according to claim 1, wherein
the end plate has a plurality of holes that axially pass through the end plate, and a through-hole that is provided with the plurality of ribs and through which the shaft is passed, and
each of the plurality of ribs is disposed on an imaginary line connecting the holes and a center of the through-hole.

4. The rotor for a rotary electric machine according to claim 1, wherein
the end plate has a wall portion having an annular shape across an entire circumference in a circumferential direction on a surface coming into contact with the shaft, and
the wall portion has an axial length smaller than an axial length of the ribs.

5. The rotor for a rotary electric machine according to claim 4, wherein the refrigerant entry portion has one end thereof in the axial direction positioned adjacently to the wall portion.

6. A rotary electric machine comprising:
the rotor for the rotary electric machine according to claim 1; and
a stator disposed outside the rotor with a predetermined gap therebetween.
